(19) United States
(12) Patent Application Publication
(10) Pub. No.: US 2019/0095048 A1
(43) Pub. Date: Mar. 28, 2019

(54) METHOD AND SYSTEM FOR DYNAMICALLY GENERATING AND EMBEDDING USER INTERFACES

(71) Applicant: Waynard Schmidt, Salt Lake City, UT (US)

(72) Inventor: Waynard Schmidt, Salt Lake City, UT (US)

(21) Appl. No.: 15/973,832

(22) Filed: May 8, 2018

Related U.S. Application Data
(60) Provisional application No. 62/563,760, filed on Sep. 27, 2017.
(60) Provisional application No. 62/563,524, filed on Sep. 26, 2017.

(51) Int. Cl. G06F 3/0481; G06F 17/24; G06Q 20/20; G06F 9/451

(52) U.S. Cl. CPC G06F 3/0481; G06F 9/451; G06Q 20/20; G06F 17/243

(57) ABSTRACT

Disclosed is a method of conducting a communication session between a first device and a second device. The method includes generating a first user interface (UI) for the communication session between the first device and the second device and transmitting the first UI to at least one of the first device and the second device. The method includes receiving a sub-user-interface (sub-UI) indicator and dynamically generating a sub-UI associated with the sub-UI indicator. The method includes transmitting the sub-UI to at least one of the first user device and the second user device and displaying the sub-UI within the first UI on at least one of the first user device and the second user device. The method includes receiving a sub-UI data from at least one of the first device and the second device and storing the sub-UI data.

### FIELD OF THE INVENTION

The present disclosure generally relates to the field of user interfaces. More specifically, the present disclosure relates to methods and systems for dynamically generating and embedding user interfaces.

### BACKGROUND OF THE INVENTION

In the last few decades, the Internet has brought a dramatic change in the way we communicate, do businesses, purchase commodities, acquire education and so on. The Internet has enabled flow of information, including entertainment, news, and financial information. Furthermore, the Internet has brought people and communities closer together by enabling various forms of interpersonal communication, such as, for example, e-mail, instant messaging, video conferencing, and social networking. Further, the Internet has allowed consumers to purchase virtually anything at any time, while providing the consumers with direct access to a wide range of markets.

Further, in today's world, there is an ever-growing section of the population, which is relying on the Internet to buy various products and services. In addition to this, people have started to anticipate the rewards of creating a successful online business. Further, with respect to online purchasing, booking travel packages, train tickets, air tickets, hotels, and merchandise, etc. have become ever more popular.

Further, various websites provide the users with an option to buy a product or service online. Accordingly, the user may be requested to make the payment by either going to a payment gateway, or opt for a Cash on Delivery option (COD). Furthermore, current systems take the user away from a primary website (e.g. an e-commerce website) for carrying out some other relevant secondary task, such as, for example, making a payment against the order and/or the booking made on the primary website. Accordingly, such directing users to other websites and/or user interfaces may be responsible for bringing down conversion rates on the primary website.

Further, whenever the user is directed to visit a secondary user interface (e.g. a website/webpage), there is a possibility that the secondary user interface may be temporarily/permanently in-operational due to hardware and/or network issues associated with the server hosting the secondary user interface. For example, the payment page (e.g. a bank payment page) for an e-commerce website may direct a user to go to an external payment website for making the payment. In some cases, the link that is used to access the payment page may be broken, and/or the website may be down due to a server issue.

Further, in some instances, users may be required to enter additional information through specially designed user interfaces according to a current context. However, selecting the appropriate user interface for a given context may be a daunting task for a regular user. For instance, while a customer is communicating with an agent, depending on a context of the communication, a sales agent may be required to accurately identify a relevant user interface and provide a link to the user that enables the user to enter additional information. However, this places a burden on the agent to correctly select a user interface among several available user interfaces.

Therefore, there is a need for improved methods and system for dynamically generating and embedding user interfaces that may overcome one or more of the abovementioned problems and/or limitations.

### SUMMARY

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to some aspects, a method for conducting a communication session between a first device and a second device is provided. The method includes generating, using a processing device, a first user interface (UI) for the communication session between the first device and the second device. For an instance, the first device may be operated by a sales agent and the second device may be operated by a customer. Further, the method includes transmitting, using a communication device, the first UI to at least one of the first device and the second device. Further, the method includes receiving, using the communication device, a sub-user-interface (sub-UI) indicator from at least one of the first device and the second device. Further, the method includes dynamically generating, using the processing device, a sub-UI associated with the sub-UI indicator. Further, the method includes transmitting, using the communication device, the sub-UI to at least one of the first user device and the second user device. Further, the method includes displaying, using a processing device, the sub-UI within the first UI on at least one of the first user device and the second user device. Further, the method includes receiving, using the communication device, a sub-UI data from at least one of the first device and the second device. Further, the method includes storing, using a storage device, the sub-UI data.

According to another aspect, a system for conducting a communication session between a first device and a second device is provided. The system includes a processing device, a communication device, and a storage device. Further, the processing device may be configured to generate a first user interface (UI) for the communication session between the first device and the second device. Further, the processing device may be configured to dynamically generate a sub-UI associated with a sub-User-Interface (sub-UI) indicator. Further, the processing device may be configured to display the sub-UI within the first UI on at least one of the first user device and the second user device. Further, the communication device may be configured to transmit the first UI to at least one of the first device and the second device. Further, the communication device may be configured to receive the sub-UI indicator from at least one of the first device and the second device. Further, the communication device may be configured to transmit the sub-UI to at least one of the first user device and the second user device. Further, the communication device may be configured to receive a sub-UI data from at least one of the first device and the second device. Further, the storage device may be configured to store the sub-UI data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is a block diagram of a system for conducting a communication session between a first device and a second device, in accordance with some embodiments.

FIG. 3 is a flow chart of a method for conducting a communication session between the first device and the second device, in accordance with some embodiments.

FIG. 4 is an illustration of a user interface of a chat window for receiving lead information from a customer, in accordance with some embodiments.

FIG. 5 is an illustration of a user interface of a chat window showing a conversation between the first user device and the second user device, in accordance with some embodiments.

FIG. 6 is an illustration of a user interface of a chat window comprising a search bar for searching products, in accordance with some embodiments.

FIG. 7 is an illustration of a user interface of a chat window showing a payment form associated with a product, in accordance with some embodiments.

FIG. 8 is an illustration a user interface shown on the first user device, in accordance with some embodiments.

FIG. 9 is a flowchart of a method for dynamically generating and embedding user interfaces, in accordance with some embodiments.

FIG. 10 is a flowchart of a method for dynamically generating and embedding user interfaces based upon receiving a section of a form indicator from a first user device, in accordance with some embodiments.

FIG. 11 is a flowchart of a method for dynamically generating and embedding user interfaces based upon receiving a section of a form indicator and a region indicator from a first user device, in accordance with some embodiments.

FIG. 12 is a flowchart of a method for dynamically generating and embedding user interfaces based upon receiving and analyzing at least one message from a first user device and/or a second user device, in accordance with some embodiments.

FIG. 13 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of dynamically generating and embedded user interfaces, embodiments of the present disclosure are not limited to use only in this context.

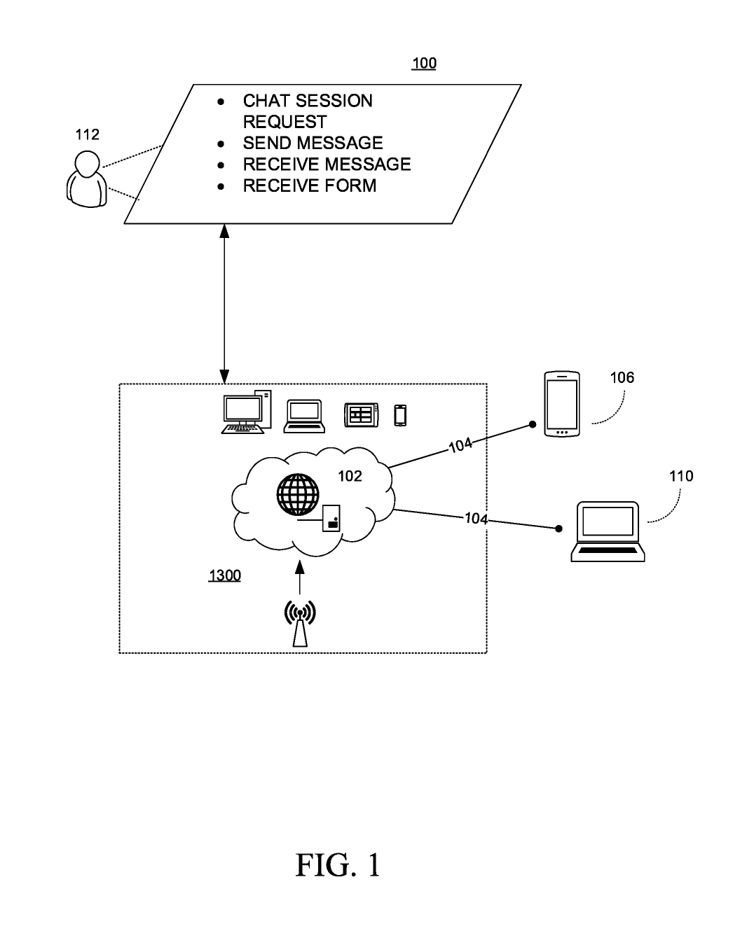

FIG. 1 is an illustration of a platform consistent with various embodiments of the present disclosure. By way of non-limiting example, the online platform 100 for dynamically generating and embedding user interfaces may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), etc., over a communication network 104, such as, but not limited to, the Internet. Further, users of the platform may include relevant parties such as, but not limited to, customers (e.g. students, online buyers etc.), sales agents (e.g. online/e-commerce sales agents) and automated conversational bots (e.g. chat-bots). Accordingly, in some instances, electronic devices operated by the one or more relevant parties may be in communication with the platform.

A user 112, such as the one or more relevant parties, may access platform 100 through a web based software application or browser. The web based software application may be embodied as, for example, but not be limited to, a website, a web application, a desktop application, and a mobile application compatible with a computing device 1300.

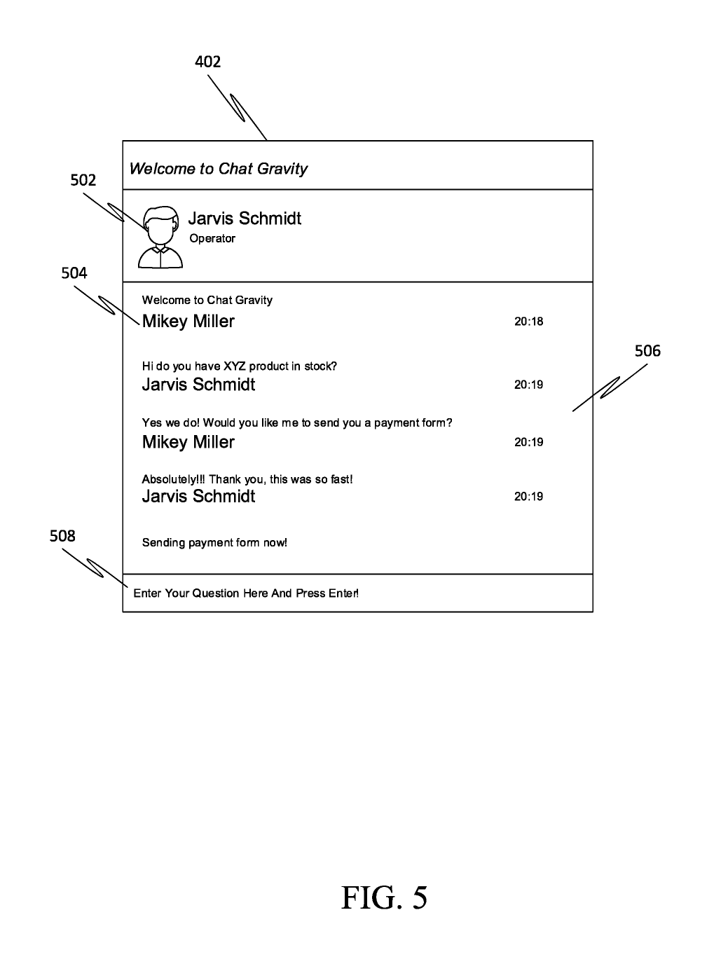

In an exemplary scenario, a company professional may address an online visitor and/or a customer who has visited the company's website. Accordingly, the company professional may use the online platform 100 to communicate with the customer. Further, the online platform 100 may generate a communication session (e.g. via a chat window, or a chatbot) on the company's website as illustrated in FIG. 5. Accordingly, the customer may enter personal details, such as, name, email address, and phone number to start the conversation through the chat window provided by the online platform 100. In an instance, the chat window may contain a form that includes fillable fields to be filled by the customer in order to start a conversation with the company professional. In an embodiment, the chat window may automatically pop up whenever the customer visits the company's website.

Further, the communication session may be regarding a product of interest to the customer. Moreover, the customer may have expressed interest in purchasing the product. Accordingly, the online platform 100 may facilitate the company professional to identify and send a payment form corresponding to the product of interest to the customer. Further, payment form may be integrated or embedded into the chat window displayed to the customer. As a result, the customer may fill up the payment form and make the payment using the payment form without leaving the chat window. Further, the customer may also receive an invoice and/or payment receipt within the chat window.

According to some aspects, a first user (e.g. a company professional) may be presented with a user interface (e.g. a chat window) that includes a list of all the products of the company. The first user may use a first user device (e.g. a mobile device). Further, the user interface (chat window) may allow the first user to search for a product and associated documents, such as, for example, product catalog and a product-specific payment form. Further, whenever a second user (e.g. a customer) visits the company's website using a second user device (e.g. a mobile device), the customer may be presented with the chat window. Further, the customer may search for a product, such as, for example, product A. Accordingly, the first user device may transmit a query (related to the product) to the online platform 100, wherein the query is raised by the customer on the chat window. Further, the first user may search for a required document and/or a user interface (e.g. a payment form) associated with the product A. In an instance, the first user may search using a product code associated with product A. Alternatively, and/or additionally, the first user may also search for the required document using code-based insertion. For example, the first user may search for the required user interface by providing a search query such as, “@payment_productcode “and/or “#payment_productcode” within a search bar associated with the chat window and/or the text box of the chat window. Accordingly, the online platform 100 may provide the payment form associated with the product A within the chat window displayed to the second user. Further, the first user may send a response through the chat window by interacting with the user interface. Accordingly, the response may include, for example, payment information corresponding to the payment form associated with the product A. Further, the second user may fill up the payment form from within the chat window. Furthermore, the second user may submit the payment form from within the chat window. Further, the first user device may receive the payment form filled by the customer. Accordingly, the online platform 100 may process a booking order associated with the product A.

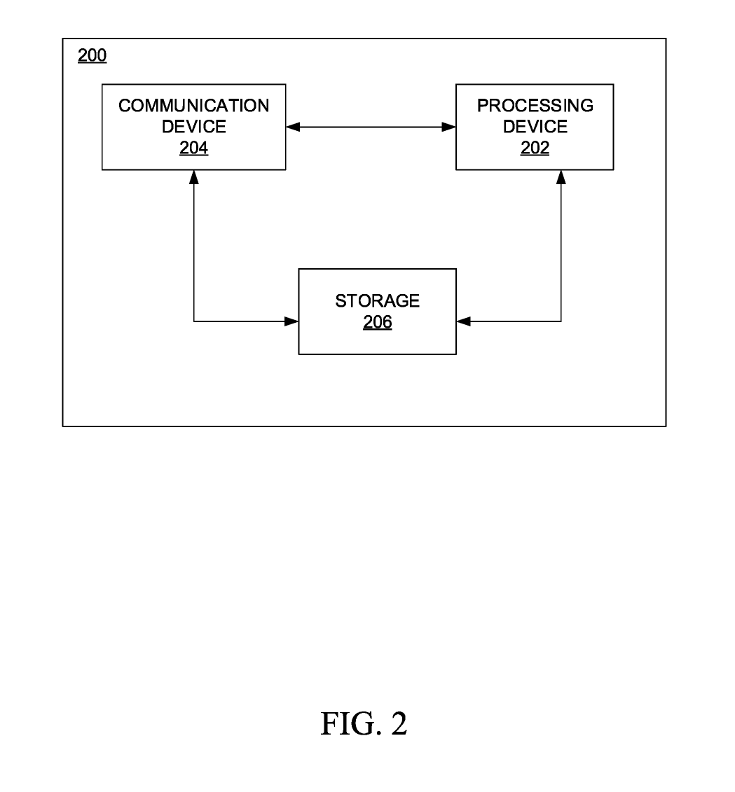

FIG. 2 is a block diagram of a system 200 for conducting a communication session between a first device and a second device, in accordance with some embodiments. For an instance, the first device may be operated by a sales agent (a first user) and the second device may be operated by a customer (a second user).

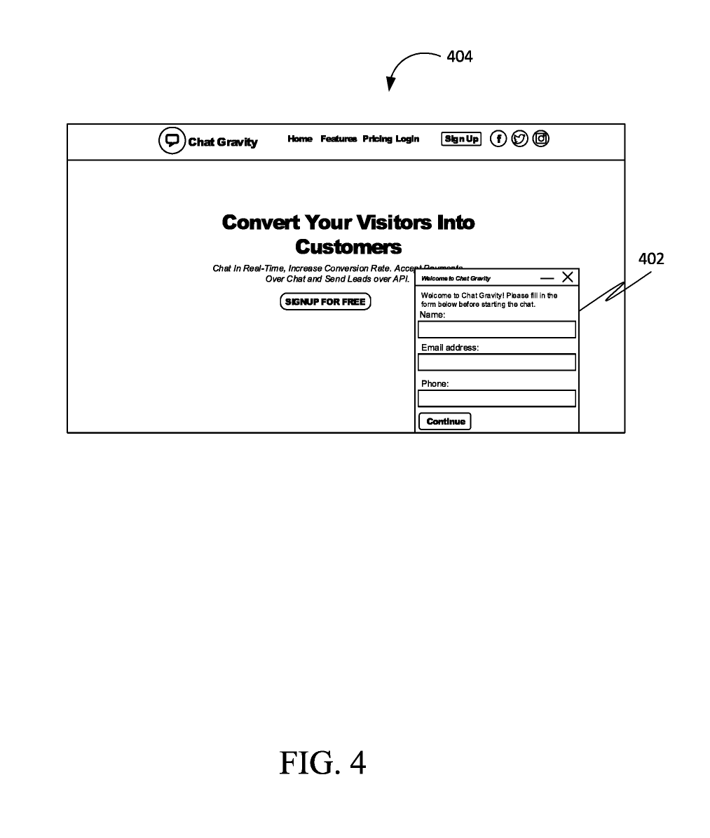

The system 200 may include a processing device 202. The processing device 202 may be configured to generate a first user interface (UI) for the communication session between the first device and the second device. Further, the first UI may be a chat user interface 402, which may allow live communication between the first device and the second device as shown in FIG. 4. The chat user interface 402 may be shown when a second device accesses a website 404 associated with the first device.

Further, the first UI 402 may be customized to match the look and feel of the website 404. For example, the first UI 402 may have the same header, side menu, footer, and style sheets as the website 404. Further, the first UI 402 may provision integration with the existing website 404 and associated business processes via HTTPS post and get operations.

FIG. 5 is an illustration of the chat user interface 402. The chat user interface 402 may be used by a first user “Jarvis Schmidt” 502 and a second user “Mikey Miller” 504 to engage in a live communication. Further, the first user 502 and the second user 504 may exchange messages in a messaging pane 506. Moreover, the messaging pane 506 may also include a text box 508, which may be used by the second user 504 to input a message. Similarly, the first user may use a text box in her chat user interface to input a message.

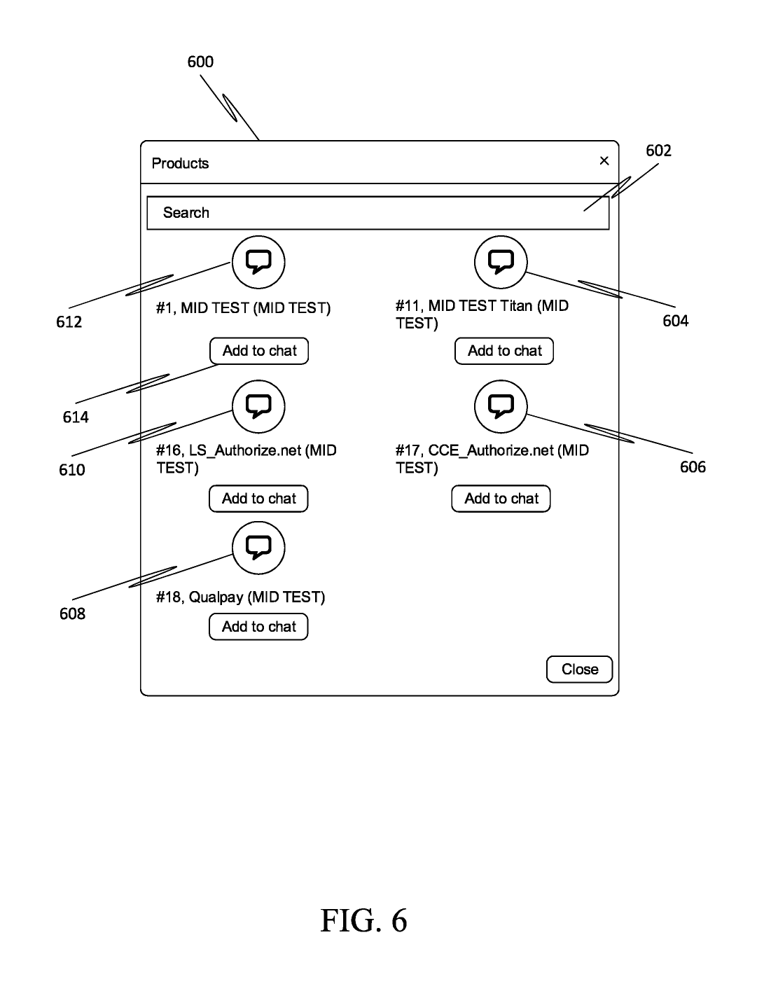

Further, the processing device 202 may be configured to dynamically generate a sub-UI associated with a sub-User-Interface (sub-UI) indicator. The sub-UI indicator may be a token that uniquely identifies a corresponding sub-UI. For example, the token may be an alphanumeric string. For example, a sub-UI indicator for a product A may be an alphanumeric string such as productA_payment_form. In an instance, the first user 502 may type the sub-UI indicator in the text box in her chat user interface. In response, the processing device 202 may dynamically generate a sub-UI associated with the sub-UI indicator productA_payment_form. Alternatively, the first user 502 may select a sub-UI indicator from a list shown in her chat user interface, as shown in FIG. 6.

In further embodiments, the chat user interface 402 may further allow for video chat between the first user 502 and the second user 504.

FIG. 6 is an illustration of a product search pane 600. The product search pane 600 may be utilized by the first user 502 to search a sub-UI indicator for a product that the second user 504 may be interested in. For an instance, the first user 502 may search the product by entering the name of the product in a search box 602. Further, the processing device 202 may provision the first user 502 with one or more related sub-UI indicators 604-612 based on the search. Accordingly, the first user 502 may select an appropriate sub-UI indicator, such as the sub-UI indicator 612, from the one or more related sub-UI indicators 604-612. For example, the first user 502 may click on a button 614 below the sub-UI indicator 612 to select the sub-UI indicator 612 and add a corresponding sub-UI to the first UI.

In some embodiments, the processing device 202 may automatically determine a sub-UI indicator of a product that the second user 504 may be interested in using automated conversational bots such as chat-bots. For an instance, the automated conversational bots may analyze the messages (such as messages in the messaging pane 506) provided by the second user 504 using Natural Language Processing (NLP). Accordingly, the processing device 202 may automatically add the sub-UI corresponding to the automatically determined sub-UI indicator to the first UI based on the analysis.

Further, the conversational bots may also recognize the currency of preference, the preferable mode of payment, the preferred language etc. based on the analysis. Accordingly, the conversational bots may auto-fill some parts (such as form fields) of the sub-UI based on the analysis.

Further, the processing device 202 may be configured to display the sub-UI within the first UI on at least one of the first user device and the second user device. For example, the sub-UI may be placed within the first UI using HTML features such as iframe, <div> etc.

Moreover, the second user 504 may change the size of the sub-UI within the first UI. For an instance, the second user 504 may drag the sub-UI within the first UI on the second user's device that may change the location/size of the sub-UI.

In some embodiments, a location of the sub-UI within the first UI may be based on a region indicator. The region indicator may be a token that uniquely identifies a location of the sub-UI within the first UI. The token may be an alphanumeric string. For example, a region indicator may be an alphanumeric string such as bottom_left. The region indicator may be a preferred location selected by the second user 504 to view the sub-UI.

In some embodiments, the processing device 202 may automatically determine a region indicator based on second user device's specification such as the type of device, screen size etc. In some embodiments, the size of the first UI may be increased based on the size of the sub-UI to allow embedding the sub-UI within the first UI.

Further, the system 200 may include a communication device 204. The communication device 204 may be configured to transmit the first UI to at least one of the first device and the second device.

Further, the communication device 204 may be configured to receive the sub-UI indicator from at least one of the first device and the second device. The communication device 204 may be further configured to receive the region indicator from at least one of the first device and the second device, wherein the processing device 202 may be further configured to create the sub-UI based on the region indicator.

Further, the communication device 204 may be configured to transmit the sub-UI to at least one of the first user device and the second user device.

Further, the communication device 204 may be configured to receive the sub-UI data from at least one of the first device and the second device.

According to some embodiments, the communication protocol used for communication via the first UI may be different from the communication protocol used for communication via the sub-UI. For example, the communication protocol used for communication via the sub-UI may have more stringent security features as compared to the communication protocol used for communication via the first UI. For example, the communication protocol used for communication via the sub-UI may include Hypertext Transfer Protocol Secure (HTTPS) protocol. However, the communication protocol used for communication via the first UI may include Hypertext Transfer Protocol (HTTP).

Further, the sub-UI may be associated with a third-party service, such a payment service provider. Accordingly, the communication protocol used for communication via the sub-UI may use a specialized Domain Name System (DNS). The specialized DNS may hide the third-party service from the second user 504. For example, the specialized DNS may enable communication that appears to the second user 504, as using the website associated with the first user 502. For example, the second user 504 visiting the website associated with the first user 502 will actually access the third-party service via the sub-UI; however, the specialized DNS may hide the third party service from the second user 504.

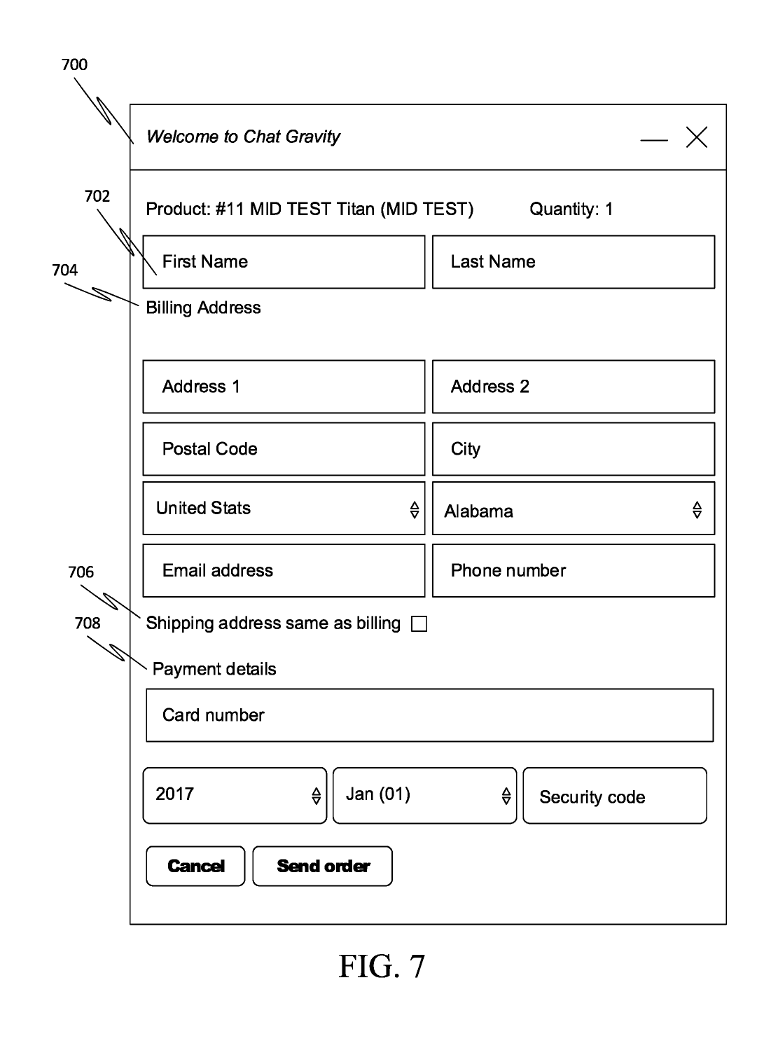

According to an exemplary embodiment, the sub-UI may be a payment form 700 as shown in FIG. 7. The payment form 700 may be displayed on the second user device. Further, the payment form 700 may include one or form fields, such as name 702, billing address 704, shipping address 706, payment details 708 etc. Further, the second user 504 may fill the one or form fields 702-708 with a sub-UI data. For example, for form field 702, the sub-UI data filled by the second user 504 may be a string “Mikey”.

Further, double-click protection may be programmed into the payment form 700 to prevent multiple payments being made by accident by the second user 504. For an instance, once the second user 504 clicks on a submit button, the payment may be sent to a Payment Card Industry Data Security Standard (PCI DSS) compliant payment system.

Further, in an exemplary embodiment, the payment form 700 may be a temporary page. For an instance, the payment form may be available to the second user 504 for a set duration of time. Further, the duration of time may be set by the first user 502. Accordingly, if the second user 504 does not make the payment in the duration of time then the sub-UI may automatically close.

Further, the PCI DSS compliant payment system may validate and process the payment. The PCI DSS compliant payment system may also return the information needed to generate a receipt to the payment form 700. Accordingly, card number, expiration date, and credit limit verification may be conducted for all credit card payments. Moreover, verification of address as well as Card Verification Value (CVV) may also be performed. Further, the second user 504 may receive a notice about the declination of the payment, if a payment fails by any of the verification checks.

Further, a basic verification may be performed by the sub-UI such as verifying authenticity of credit card number. For an instance, the sub-UI may analyze the number of digits of the credit card number entered by the second user 504. Further, the sub-UI may ensure that the Credit Card or Debit Card Number follows a proper format.

Further, the system 200 may include a storage device 206. The storage device 206 may be configured to store the sub-UI data.

Further, in an exemplary embodiment, the second user 504 may add one or more users to the first UI and/or sub-UI; for example, to make payments. For an instance, the second user 504 may be a manager at a firm. The managers may not be authorized to make payments for the firm. The payments may be handled by accounts department of the firm. Accordingly, the second user 504 may add one or more users from the accounts department of the firm to enter the payment details in the sub-UI.

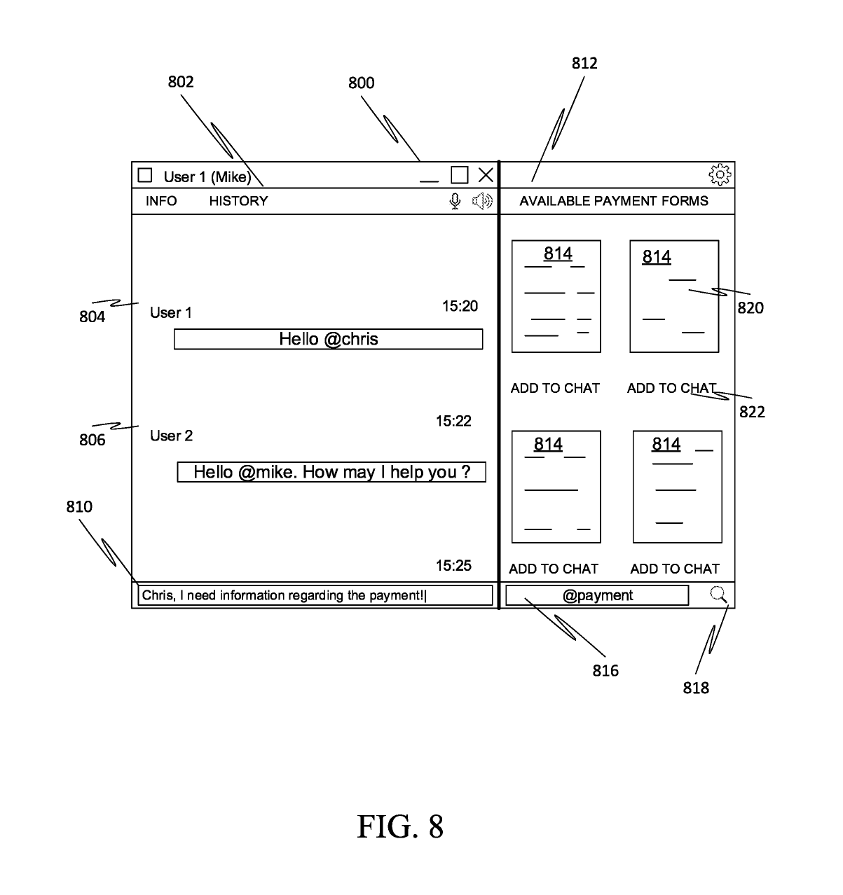

FIG. 8 is an illustration of a first UI 800 including one or more panes. For an instance, the first UI 800 may be divided into two panes, wherein a first pane 802 in the first UI 800 may be configured to display one or more messages exchanged between a first user “Mike” 804 and a second user “Chris” 806. Accordingly, the one or more messages may be displayed. Further, the first user 804 and the second user 806 may input text in a chat box 810. Moreover, a second pane 812 in the first UI 800 may be configured to display a list of sub-UI indicators 814. For an instance, the first user 804 may input a text into a sub-UI indicator search box 816 and click on a search button 818. Accordingly, the list of sub-UI indicators 814 may be displayed in the second pane 812. Further, the first user 804 may select a sub-UI indicator, such as a sub-UI indicator 820 by clicking on an “add to chat” button 822 that may be present below the sub-UI indicator 820.

Further, the second pane 812 may be updated based on input received from at least one of the first user 804 and the second user 806. For an instance, the first user 804 may input text into the sub-UI indicators search box 816 and click on the search button 818, the processing device 202 may analyze the input text and update the list of sub-UI indicators.

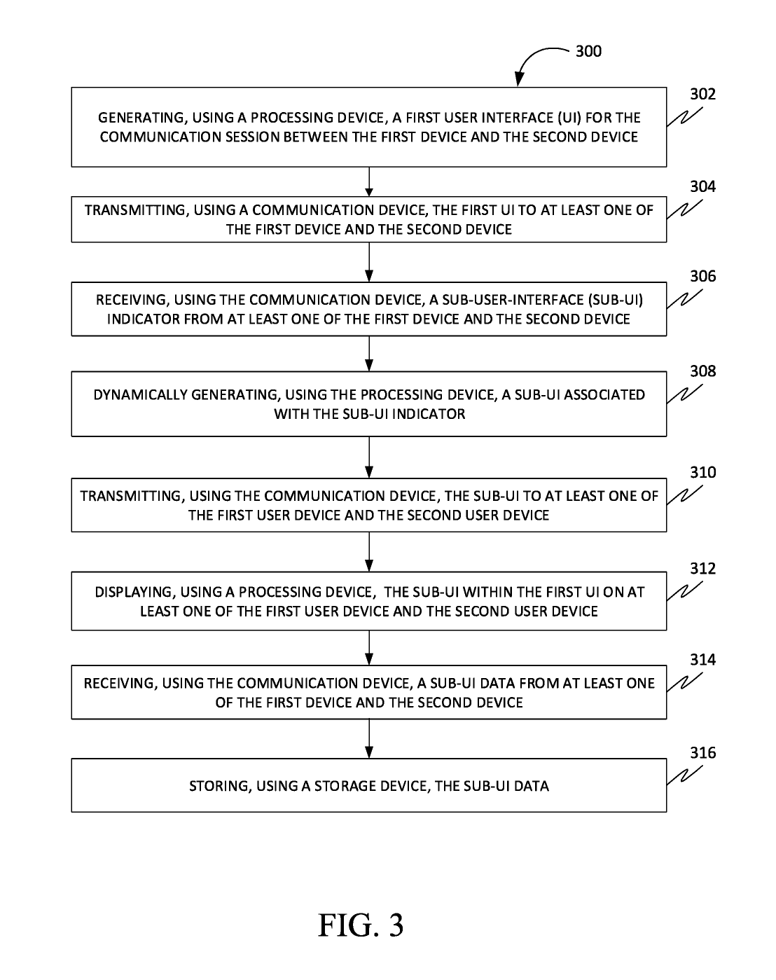

FIG. 3 is a flow chart of a method 300 for conducting a communication session between a first device and a second device, in accordance with some embodiments. At 302, the method includes generating, using a processing device 202, a first user interface (UI) for the communication session between the first device and the second device. For an instance, the first device may be operated by a sales agent and the second device may be operated by a customer. This is explained in further detail in conjunction with FIG. 2 above.

Further, at 304, the method includes transmitting, using a communication device 204, the first UI to at least one of the first device and the second device. Further, at 306, the method includes receiving, using the communication device 204, a sub-user-interface (sub-UI) indicator from at least one of the first device and the second device. This is explained in further detail in conjunction with FIG. 2 above. Further, at 308, the method includes dynamically generating, using the processing device 202, a sub-UI associated with the sub-UI indicator. This is explained in further detail in conjunction with FIG. 2 above. Further, at 310, the method includes transmitting, using the communication device 204, the sub-UI to at least one of the first user device and the second user device. Further, at 312, the method includes displaying, using the processing device 202, the sub-UI within the first UI on at least one of the first user device and the second user device. Further, at 314, the method includes receiving, using the communication device 204, a sub-UI data from at least one of the first device and the second device. This is explained in further detail in conjunction with FIG. 2 above.

Further, at 316, the method includes storing, using a storage device 206, the sub-UI data.

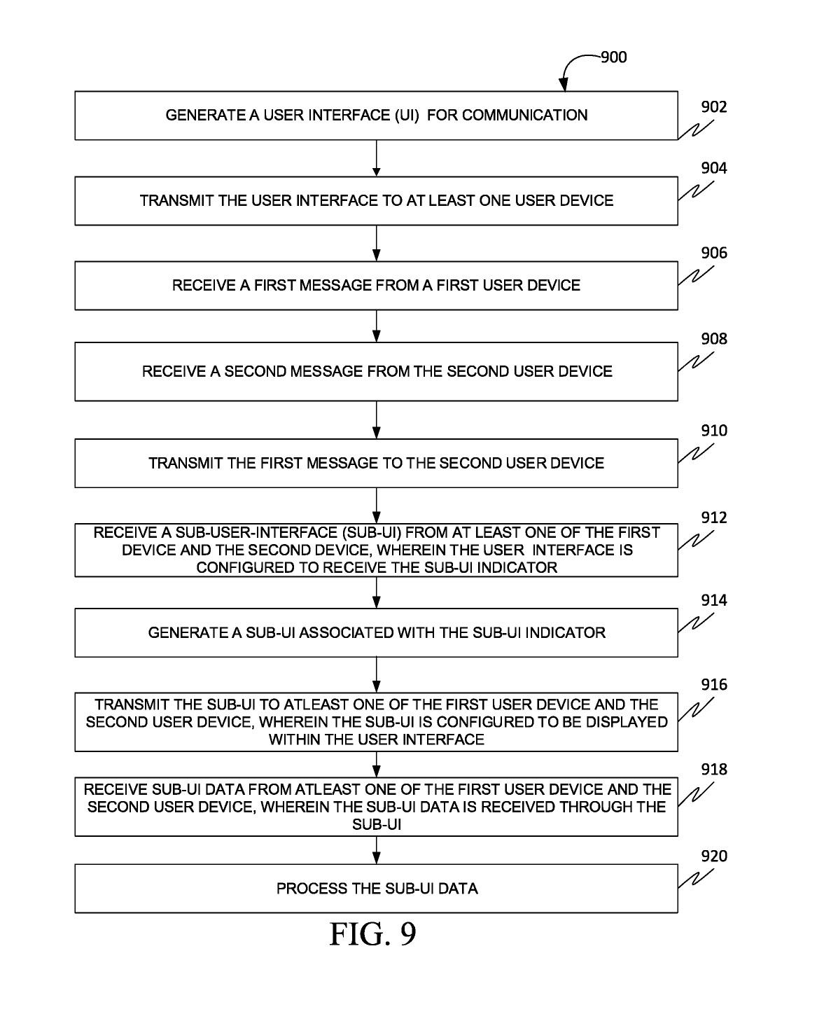

FIG. 9 is a flowchart of a method 900 that dynamically generates and embeds user interfaces, in accordance with some embodiments. Further, at 902, the method 900 may include a step of generating, using a processing device 202, a user interface (UI) for communication. In an instance, the user interface generated by the online platform 100 may be the chat window, which allows live communication between an agent and a customer.

At 904, the method 900 may include a step of transmitting, using a communication device 204, the user interface to at least one user device (e.g. user devices corresponding to the agent and/or the customer).

At 906, the method 900 may include a step of receiving, using the communication device 204, a first message from the first user device.

Further, at 908, the method 900 may include a step of receiving, using the communication device 204, a second message from the second user device.

At 910, the method 900 may include a step of transmitting, using the communication device 204, the first message to the second user device. Further, the method 900 may include a step of transmitting, using the communication device 204, the second message to the first user device. In other words, the online platform 100 may facilitate exchange of messages between the first user device and the second user device.

Further, at 912, the method 900 may include a step of receiving, using the communication device 204, a sub-UI indicator from at least one of the first device and the second device, wherein the user interface is configured to receive the sub-UI indicator. In an instance, the sub-UI may be a payment form. Accordingly, the sub-UI indicator may be a token that uniquely identifies a corresponding sub-UI. For example, a main UI (i.e. the user interface) may be indicated by the token chat_window, while the sub-UI may be indicated by the token payment_form.

Further, at 914, the method 900 may include a step of generating, using the processing device 202, a sub-UI associated with the sub-UI indicator.

At 916, the method 900 may include a step of transmitting, using the communication device 204, the sub-UI to at least one of the first user device and the second user device, wherein the sub-UI is configured to be displayed within the user interface. For example, the payment form may be displayed within the chat window presented to the customer.

Further, at 918, the method 900 may include a step of receiving, using the communication device 204, sub-UI data from at least one of the first device and the second device, wherein the sub-UI data is received through the sub-UI. Further, sub-UI data may be the data received through the sub-UI. For example, in the case of a chat window with an embedded payment form (i.e. sub-UI), payment information such as name, credit card number, expiry date, etc. may constitute the sub-UI data.

Further, at 920, the method 900 may include a step of processing, using the processing device 202, the sub-UI data.

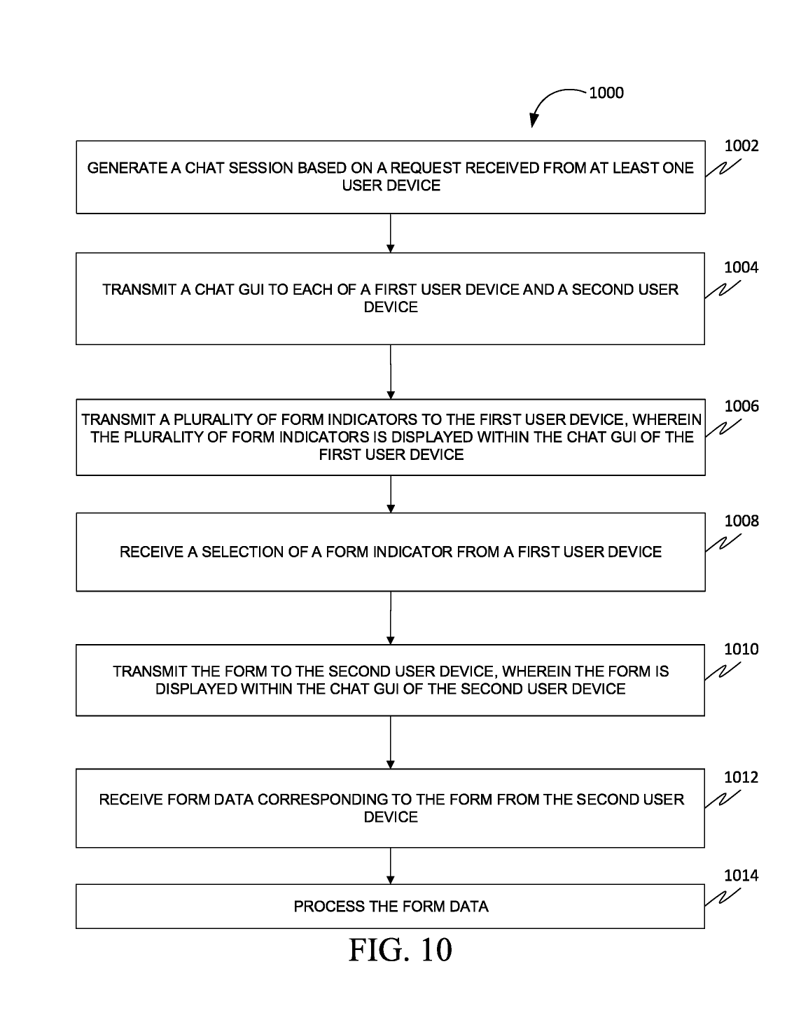

FIG. 10 is a flowchart of a method 1000 that dynamically generates and embeds user interfaces based upon receiving a section of a form indicator from a first user device, in accordance with some embodiments. Further, at 1002, the method 1000 may include a step of generating, using the processing device 202, a chat session based on a request received from at least one user device.

At 1004, the method 1000 may include a step of transmitting, using the communication device 204, a chat GUI to each of a first user device and a second user device.

Further, at 1006, the method 1000 may include a step of transmitting, using the communication device 204, a plurality of form indicators to the first user device, wherein the plurality of form indicators are displayed within the chat GUI of the first user device.

At 1008, the method 1000 may include a step of receiving, using the communication device 204, a selection of a form indicator from a first user device.

Further, at 1010, the method 1000 may include a step of transmitting, using the communication device 204, the form to the second user device, wherein the form is displayed within the chat GUI of the second user device.

At 1012, the method 1000 may include a step of receiving, using the communication device 204, the form data corresponding to the form from the second user device.

At 1014, the method 1000 may include a step of processing, using the processing device 202, the form data.

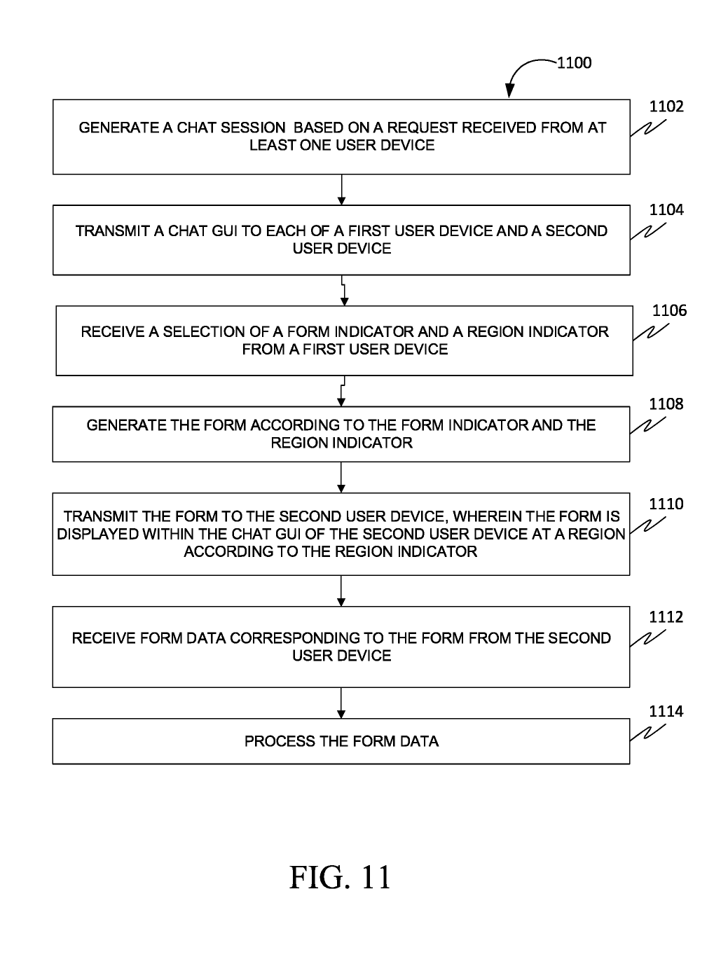

FIG. 11 is a flowchart of a method 1100 that dynamically generates and embeds user interfaces based upon receiving a section of a form indicator and a region indicator from a first user device, in accordance with some embodiments. Further, at 1102, the method 1100 may include a step of generating, using a processing device 202, a chat session based on a request received from at least one user device.

At 1104, the method 1100 may include a step of transmitting, using a communication device 204, a chat GUI to each of a first user device and a second user device.

Further, at 1106, the method 1100 may include a step of receiving, using the communication device 204, a selection of a form indicator and a region indicator from a first user device.

Further, at 1108, the method 1100 may include a step of generating, using the processing device 202, the form according to the form indicator and the region indicator.

At 1110, the method 1100 may include a step of transmitting, using the communication device 204, the form to the second user device, wherein the form is displayed within the chat GUI of the second user device at a region according to the region indicator.

At 1112, the method 1100 may include a step of transmitting, using the communication device 204, the form data corresponding to the form from the second user device. Further, at 1114, the method 1100 may include a step of processing, using the processing device 202, the form data.

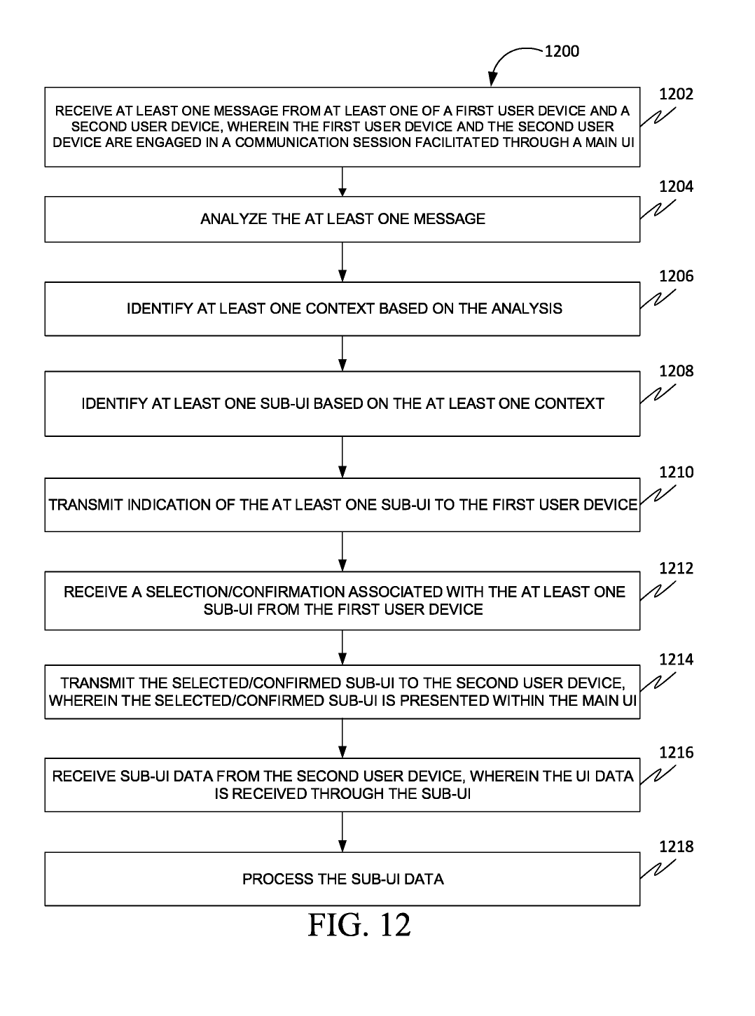

FIG. 12 is a flowchart of a method 1200 that dynamically generates and embeds user interfaces based upon receiving and analyzing at least one message from a first user device and/or a second user device, in accordance with some embodiments. Further, at 1202, the method 1200 may include a step of receiving, using the communication device 204, at least one message from at least one of a first user device and a second user device, wherein the first user device and the second user device are engaged in a communication session facilitated through a main UI. In an instance, the message may be in the form of text, voice, and image, etc.

Further, at 1204, the method 1200 may include a step of analyzing, using the processing device 202, the at least one message. In an instance, the analysis may include, such as, for example, semantic analysis, NLP analysis, and image analysis.

At 1206, the method 1200 may include a step of identifying, using the processing device 202, at least one context (payment for a specified product) based on the analysis.

Further, at 1208, the method 1200 may include a step of identifying, using the processing device 202, at least one sub-UI (e.g. payment form for the specified product) based on the at least one context.

At 1210, the method 1200 may include a step of transmitting, using the communication device 204, indication of the at least one sub-UI to the first user device.

At 1212, the method 1200 may include a step of receiving, using the communication device 204, a selection/confirmation associated with the at least one sub-UI from the first user device.

Further, at 1214, the method 1200 may include a step of transmitting, using the communication device 204, the selected/confirmed sub-UI to the second user device, wherein the selected/confirmed sub-UI (e.g. payment form) is presented within the main UI (e.g. chat window).

Further, at 1216, the method 1200 may include a step of receiving, using the communication device 204, sub-UI data (e.g. payment information) from the second user device, wherein the UI data is received through the sub-UI.

Further, at 1218, the method 1200 may include a step of processing, using the processing device 202, the sub-UI data.

According to an exemplary embodiment, a merchant may install a chat widget on their website as illustrated in FIG. 4. Further, the visitors on the merchant's website may initiate a chat by filling out lead information, such as, name, email address. Further, the visitor may be connected to merchant's sales team via live chat as illustrated in FIG. 5 and request a product. Accordingly, a user interface as illustrated in FIG. 6 may be displayed to the agent. Further, the sales team may search for the product requested by the visitor and sends the payment form corresponding to the product to the visitor. Further, the visitor may be instantly presented with the payment form within the chat window as illustrated in FIG. 7.

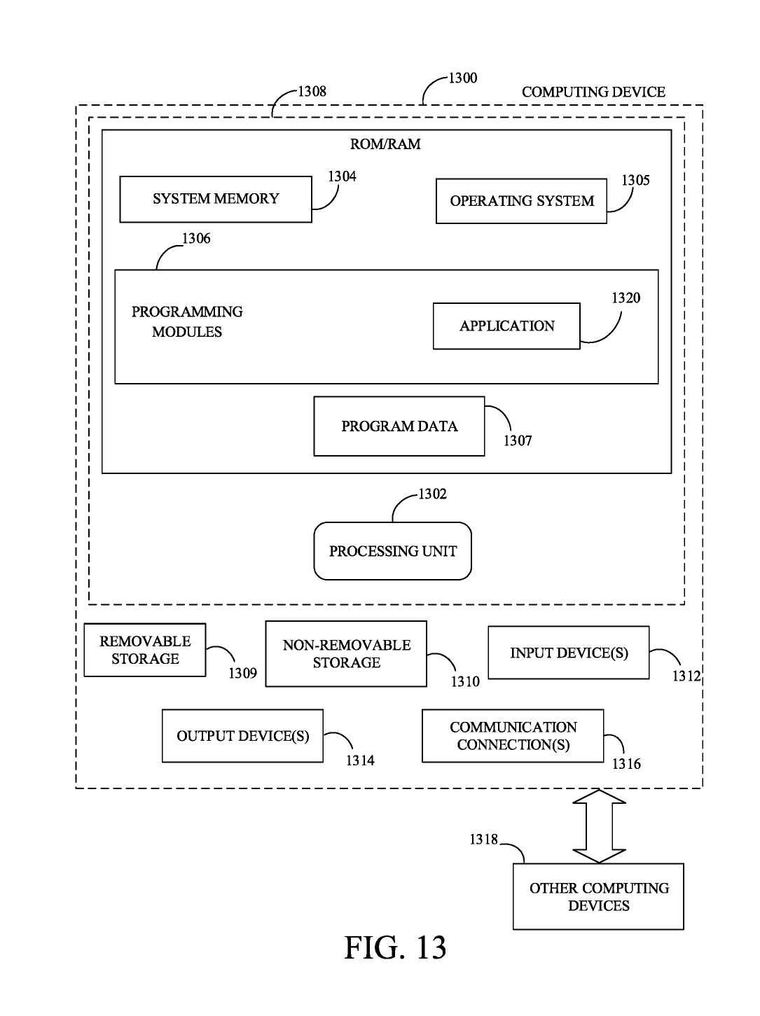

FIG. 13 is a block diagram of a system including computing device 1300. Consistent with an embodiment of the disclosure, the aforementioned storage device 206 and processing device 202 may be implemented in a computing device, such as computing device 1300 of FIG. 13. Any suitable combination of hardware, software, or firmware may be used to implement the memory storage and processing unit. For example, the storage device 206 and the processing device 202 may be implemented with computing device 1300 or any of other computing devices 1318, in combination with computing device 1300. The aforementioned system, device, and processors are examples and other systems, devices, and processors may comprise the aforementioned storage device 206 and processing device 202, consistent with embodiments of the disclosure.

With reference to FIG. 13, a system consistent with an embodiment of the disclosure may include a computing device or cloud service, such as computing device 1300. In a basic configuration, computing device 1300 may include at least one processing unit 1302 and a system memory 1304. Depending on the configuration and type of computing device, system memory 1304 may comprise, but is not limited to, volatile (e.g. random access memory (RAM)), non-volatile (e.g. read-only memory (ROM)), flash memory, or any combination. System memory 1304 may include operating system 1305, one or more programming modules 1306, and may include a program data 1307. Operating system 1305, for example, may be suitable for controlling computing device 1300's operation. In one embodiment, programming modules 1306 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 13 by those components within a dashed line 1308.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 13 by a removable storage 1309 and a non-removable storage 1310. Computer storage media may include volatile and nonvolatile, removable and non-removable media implemented in any method or technology for storage of information, such as computer-readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 1300. Any such computer storage media may be part of device 1300. Computing device 1300 may also have input device(s) 1312 such as a keyboard, a mouse, a pen, a sound input device, a touch input device, etc. Output device(s) 1314 such as a display, speakers, a printer, etc. may also be included. The aforementioned devices are examples and others may be used.

Computing device 1300 may also contain a communication connection 1316 that may allow device 1300 to communicate with other computing devices 1318, such as over a network in a distributed computing environment, for example, an intranet or the Internet. Communication connection 1316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1304, including operating system 1305. While executing on processing unit 1302, programming modules 1306 (e.g., application 1320 such as a media player) may perform processes including, for example, one or more stages of methods, algorithms, systems, applications, servers, databases as described above. The aforementioned process is an example, and processing unit 1302 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

What is claimed is:

1. The method of conducting a communication session between a first device and a second device, the method comprising:
generating, using a processing device, a first user interface (UI) for the communication session between the first device and the second device;
transmitting, using a communication device, the first ui to at least one of the first device and the second device;
receiving, using the communication device, a sub-user-interface (sub-UI) indicator from at least one of the first device and the second device;
dynamically generating, using the processing device, a sub-UI associated with the sub-UI indicator;
transmitting, using the communication device, the sub-UI to at least one of the first user device and the second user device;
displaying, using a processing device, the sub-UI within the first UI on at least one of the first user device and the second user device;
receiving, using the communication device, a sub-UI data from at least one of the first device and the second device, and
storing, using a storage device, the sub-UI data.

2. The method of claim 1, wherein the first device is operated by a sales agent and the second device is operated by a customer.

3. The method of claim 1, wherein the first UI is a chat user interface which allows live communication between the first device and the second device.

4. The method of claim 3, wherein the chat user interface includes one or more panes, wherein a first pane in the one or more panes is configured to display one or more messages exchanged between the first user device and the second user device, wherein a second pane in the one or more panes is configured to display the sub-UI.

5. The method of claim 4, wherein the second pane is updated based on input received from at least one of the first device and the second device.

6. The method of claim 1 wherein the sub-UI indicator is a token that uniquely identifies a corresponding sub-UI.

7. The method of claim 1 further includes receiving, using the communication device, a region indicator from at least one of the first device and the second device, wherein the dynamically generating, using the processing device, the sub-UI associated with the sub-UI indicator includes creating the sub-UI based on the region indicator.

8. The method of claim 1, wherein the sub-UI includes a form with one or more form fields, wherein the sub-UI data is received through the form.

9. The method of claim 8, wherein the sub-UI includes a payment form including one or form fields, wherein the payment form is displayed within the chat window presented to the customer.

10. The method of claim 1, wherein the communication protocol used for communication via the first UI is different from the communication protocol used for communication via the sub-UI.

11. The system of conducting a communication session between a first device and a second device, the system comprising:
a processing device configured to:
generate a first user interface (UI) for the communication session between a first device and a second device;
dynamically generate a sub-UI associated with a sub-User-Interface (sub-UI) indicator; and
display the sub-UI within the first UI on at least one of the first user device and the second user device; and
a communication device configured to:
transmit the first UI to at least one of the first device and the second device;
receive the sub-UI indicator from at least one of the first device and the second device;
transmit the sub-UI to at least one of the first user device and the second user device; and
receive a sub-UI data from at least one of the first device and the second device; and
a storage device configured to store the sub-UI data.

12. The system of claim 11, wherein the first device is operated by a sales agent and the second device is operated by a customer.

13. The system of claim 11, wherein the first UI is a chat user interface which allows live communication between the first device and the second device.

14. The system of claim 13, wherein the chat user interface includes one or more panes, wherein a first pane in the one or more panes is configured to display one or more messages exchanged between the first user device and the second user device, wherein a second pane in the one or more panes is configured to display the sub-UI.

15. The system of claim 14, wherein the second pane is updated based on input received from at least one of the first device and the second device.

16. The system of claim 11 wherein the sub-UI indicator is a token that uniquely identifies a corresponding sub-UI.

17. The system of claim 11, wherein the communication device is further configured to receive a region indicator from at least one of the first device and the second device, wherein the processing device is further configured to create the sub-UI based on the region indicator.

18. The system of claim 11, wherein the sub-UI includes a form with one or more form fields, wherein the sub-UI data is received through the form.

19. The system of claim 18, wherein the sub-UI includes a payment form including one or form fields, wherein the payment form is displayed within the chat window presented to the customer.

20. The system of claim 11, wherein the communication protocol used for communication via the first UI is different from the communication protocol used for communication via the sub-UI.
